(19) United States
(12) Patent Application Publication
(10) Pub. No.: US 2010/0060713 A1
(43) Pub. Date: Mar. 11, 2010

(54) System and Method for Enhancing Noverbal Aspects of Communication

(75) Inventors: Jeffrey C. Snyder, Fairport, NY (US); Edward Covannon, Ontario, NY (US)

Correspondence Address: EASTMAN KODAK COMPANY;PATENT LEGAL STAFF, 343 STATE STREET, ROCHESTER, NY, 14650-2201, US

(73) Assignee: Eastman Kodak Company, Rochester, NY (US)

(21) Appl. No.: 12/207,707

(22) Filed: Sep. 10, 2008

(51) Int. Cl. H04N 7/14; G06K 9/00

(52) U.S. Cl. 348/14.01; 382/117; 348/E07.077

(57) ABSTRACT

Systems and methods of providing behavioral modification information to one or more participants of a communication. Information related to a communication between a first and second participant is obtained and used to identify behavioral modifications for at least one of the first and second participants. The behavioral modifications can be output to a display for a human to interpret. When one of the participants is computer-generated the behavioral modifications can be output to control the computer-generated participant.

### FIELD OF THE INVENTION

The present invention relates to enhancing nonverbal aspects of communication.

### BACKGROUND OF THE INVENTION

Humans can communicate either locally (i.e., face-to-face) or remotely. Remote communications typically comprise either voice-only or text-only communication, which involve only one of the five human senses. In contrast, local communications involve at least two human senses, hearing and vision. It is well recognized that the ability to both see and hear a person provides great advantages to local communications over remote communications. For example, whereas sarcasm can typically be detected by hearing a voice, and possible seeing certain facial expressions, it is relatively common for sarcasm to be misunderstood in text communications, such as electronic mail. Similarly, there are a number of different non-verbal cues that people use to convey important information during local communications. These non-verbal cues can include eye contact information, hand motions, facial expressions and/or the like.

### SUMMARY OF THE INVENTION

Although video conferencing allows participants of remote communications to both hear and see each other, similar to local communications, these systems still fail to provide all of the information that can be obtained from local communications. For example, the field of view of a video capture device may be very limited, and thus much of the visual information that could be obtained from a local communication is not conveyed by video conferencing. Moreover, the arrangement of video displays and video capture devices in some video conference systems may result in one participant appearing to gaze in a direction other than directly at the other participant. This can be distracting and interpreted by the other participant as a sign of disinterest in the communication.

The auditory and/or visual information obtained by participants to local communications or remote communications is typically interpreted by the participants based on their own knowledge and experience. Humans necessarily have a limited base of knowledge and experience, and accordingly may convey unintentional meanings through non-verbal communication. Thus, a participant may not recognize that eye contact in Iran does not mean the same thing as eye contact in the United States. Accordingly, the context of nonverbal cues is important. For example, a raised eyebrow in one situation is not the same as a raised eyebrow in a second situation; a stare between two male boxers does not mean the same as a stare between mother and daughter. Therefore, effective communication requires not only the accurate transmission of eye contact and gaze information but also eye contact and gaze information that is appropriate for the intentions of the participants to the communication.

Exemplary embodiments of the present invention overcome the above-identified and other deficiencies of prior communication techniques by providing behavioral modification information to one or more participants of a communication. Specifically, information related to a communication between a first and second participant is obtained and used to identify behavioral modifications for at least one of the first and second participants. The behavioral modifications can be output to a display for a human to interpret. When one of the participants is computer-generated the behavioral modifications can be output to control the computer-generated participant.

The obtained information can include demographic information, environmental information, goal information or gaze cone vector information. The demographic information can be provided by one of the first and second participants or can be obtained by analysis of an image of one of the first and second participants. The demographic information can include information about gender, age, economic circumstances, profession, physical size, capabilities, disabilities, education, domicile, physical location, cultural origins and/or ethnicity.

The identified behavioral modifications include eye contact information, such as information about a direction of a gaze and duration of the gaze in the direction.

Other objects, advantages and novel features of the present invention will become apparent from the following detailed description of the invention when considered in conjunction with the accompanying drawings.

### BRIEF DESCRIPTION OF THE DRAWINGS

FIG. 1a is a block diagram of an exemplary display screen in accordance with the present invention.

FIG. 1b is a block diagram of an exemplary gaze cone and gaze cone vector.

FIG. 2 is a block diagram of an exemplary system in accordance with the present invention.

FIG. 3 is a flow diagram of an exemplary method in accordance with the present invention.

### DETAILED DESCRIPTION OF THE INVENTION

As will be described in more detail below, exemplary embodiments of the present invention obtain demographic, goal, environmental and/or gaze cone information about one or more participants of a communication in order to generate behavioral modification information to achieve the goals of one or more of the participants. This information can be input by one of the participants, obtained through image processing techniques and/or inferred from some or all of the information input by the participant, obtained by image processing techniques and/or from gaze cone information.

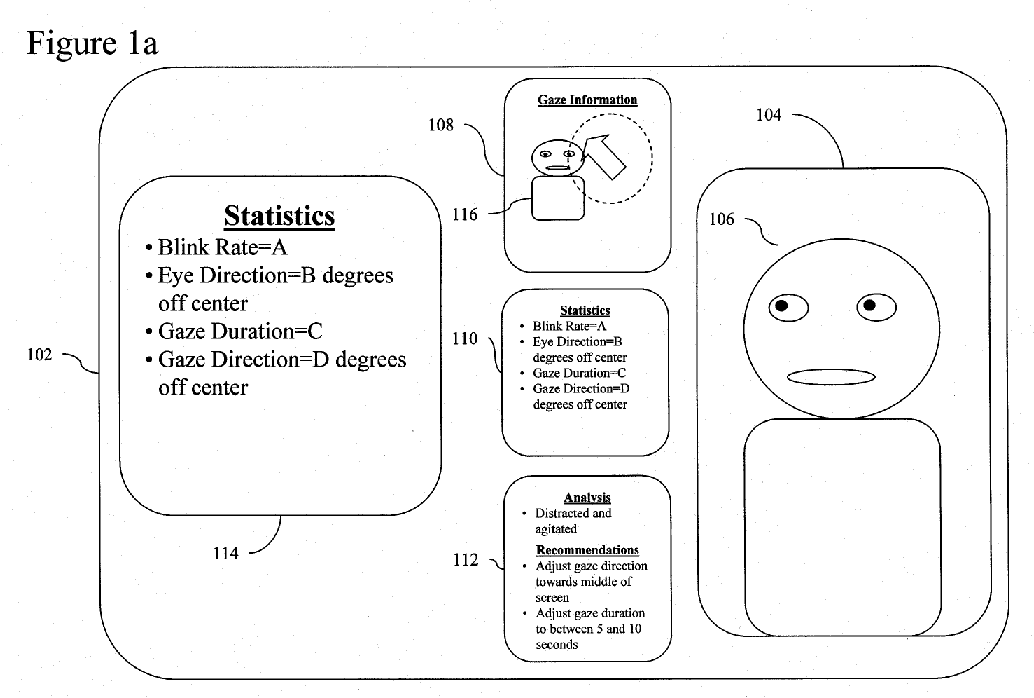

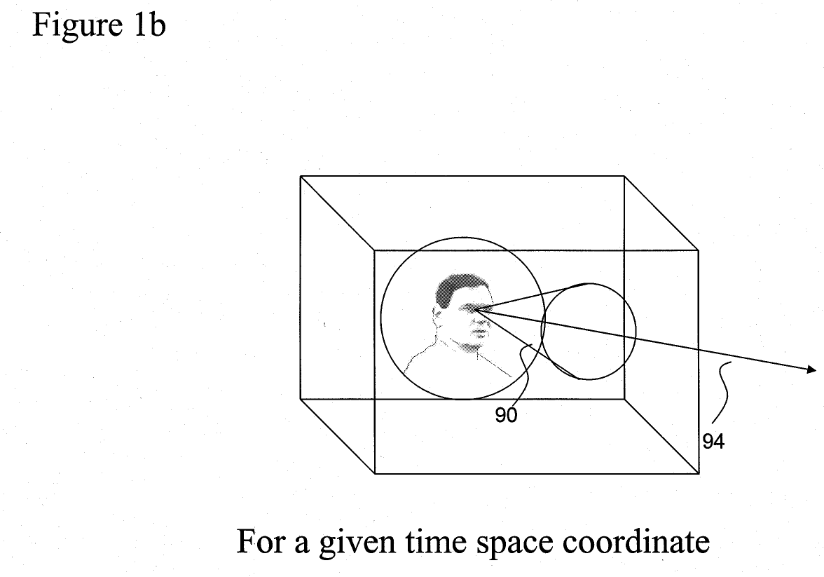

FIG. 1a is a block diagram of an exemplary display screen in accordance with the present invention. The display screen 102 is presented to a first participant that is in communication with at least a second participant. As used herein, the term participant can be a human or computer-generated participant. The display screen 102 includes portion 104 that displays another participant to the communication 106. Display screen 102 also includes portions 108-114 that display information about the first and/or second participants. Gaze information is included in portion 108, statistics information is included in portion 110 and analysis and recommendation information is included in portion 112. Portion 114, which is illustrated as displaying statistics, is a portion that can display any of the portions 108-112, but in a larger format than that of portions 108-112.

As illustrated in FIG. 1a, gaze information portion 108 displays information about what the second participant (i.e., the remote participant) is currently looking at, which in the illustrated example is only a portion of the first participant 116. This portion includes computer graphic visuals such as circles and arrows to illustrate the direction of the second participant's gaze.

Statistics portion 10 displays information about the second participant's gaze and eye contact related data and statistics, such as blink rate, eye direction, gaze duration and gaze direction. Portion 112 displays an analysis of the second participant, as well as recommendations for the first participant. As will be described in more detail below, this information can be obtained from the second participant's gaze and eye contact information in both verbal and graphic form, such an analysis based upon knowledge of the remote physical context of the second participant, and knowledge of the social, psychological, behavioral, and physical characteristics of the second participant.

Although not illustrated, the screen of FIG. 1a can include a capture device, which can, for example, employ on-axis capture technology. The capture device is used to provide the first participant's image 116 in portion 108. It should be recognized that the display screen of FIG. 1a is merely exemplary and not intended to be a literal interpretation of a graphical interface for the system.

FIG. 1b is a block diagram of an exemplary gaze cone and gaze cone vector. A gaze cone source (which may be any real or synthetic human, animal, mechanical or imaginary potential source of a visual capture cone) is perceived as being capable of capturing a cone of light rays, the axis of such a cone being the vector for the gaze cone for any given time when eyes, lenses, etc. are by convention said to be open and in capture mode.

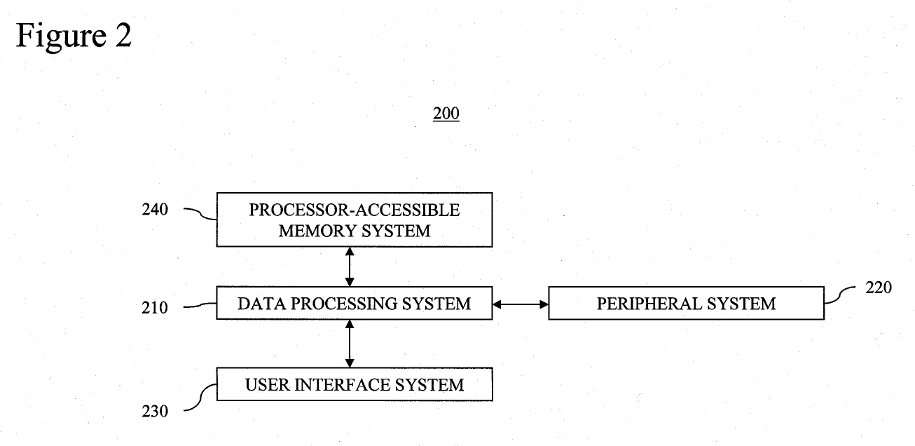

FIG. 2 is a block diagram of an exemplary system in accordance with the present invention. The system 200 includes a data processing system 210, a peripheral system 220, a user interface system 230, and a processor-accessible memory system 240. The processor-accessible memory system 240, the peripheral system 220, and the user interface system 230 are communicatively connected to the data processing system 210.

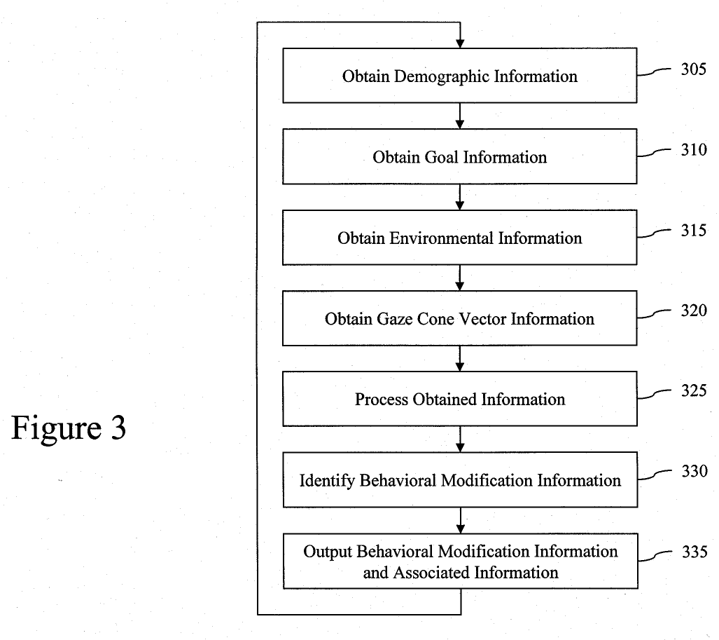

The data processing system 210 includes one or more data processing devices that implement the processes of the various embodiments of the present invention, including the process of FIG. 3 described herein. The phrases “data processing device” or “data processor” are intended to include any data processing device, such as a central processing unit (“CPU”), a desktop computer, a laptop computer, a mainframe computer, a personal digital assistant, a Blackberry™, a digital camera, cellular phone, or any other device for processing data, managing data, or handling data, whether implemented with electrical, magnetic, optical, biological components, or otherwise.

The processor-accessible memory system 240 includes one or more processor-accessible memories configured to store information, including the information needed to execute the processes of the various embodiments of the present invention, including the example process of FIG. 3 described herein. The processor-accessible memory system 240 may be a distributed processor-accessible memory system including multiple processor-accessible memories communicatively connected to the data processing system 210 via a plurality of computers or devices. On the other hand, the processor-accessible memory system 240 need not be a distributed processor-accessible memory system and, consequently, may include one or more processor-accessible memories located within a single data processor or device.

The phrase “processor-accessible memory” is intended to include any processor-accessible data storage device, whether volatile or nonvolatile, electronic, magnetic, optical, or otherwise, including but not limited to, floppy disks, hard disks, Compact Discs, DVDs, flash memories, ROMs, and RAMs.

The phrase “communicatively connected” is intended to include any type of connection, whether wired or wireless, between devices, data processors, or programs in which data may be communicated. Further, the phrase “communicatively connected” is intended to include a connection between devices or programs within a single data processor, a connection between devices or programs located in different data processors, and a connection between devices not located in data processors at all. In this regard, although the processor-accessible memory system 240 is shown separately from the data processing system 210, one skilled in the art will appreciate that the processor-accessible memory system 240 may be stored completely or partially within the data processing system 210. Further in this regard, although the peripheral system 220 and the user interface system 230 are shown separately from the data processing system 210, one skilled in the art will appreciate that one or both of such systems may be stored completely or partially within the data processing system 210.

The peripheral system 220 may include one or more devices configured to provide digital content records to the data processing system 210. For example, the peripheral system 220 may include digital video cameras, cellular phones, motion trackers, microphones, or other data processors. The data processing system 210, upon receipt of digital content records from a device in the peripheral system 220, may store such digital content records in the processor-accessible memory system 240.

The user interface system 230 may include a mouse, a keyboard, another computer, or any device or combination of devices from which data is input to the data processing system 210. In this regard, although the peripheral system 220 is shown separately from the user interface system 230, the peripheral system 220 may be included as part of the user interface system 230.

The user interface system 230 also may include an audio or visual display device, a processor-accessible memory, or any device or combination of devices to which data is output by the data processing system 210. In this regard, if the user interface system 230 includes a processor-accessible memory, such memory may be part of the processor-accessible memory system 240 even though the user interface system 230 and the processor-accessible memory system 240 are shown separately in FIG. 2.

FIG. 3 is a flow diagram of an exemplary method in accordance with the present invention. Initially, the system obtains demographic information (step 305). Demographic information can include, for example, gender, age, economic circumstances, profession, physical size and capabilities or disabilities, education, domicile, physical location, cultural origins and/or ethnicity. The demographic information is used to account for a number of factors, such as cultural, social, psychological and physiological differences in a manner that allows the system to provide recommendations for, or directly alter (in the case of a computer generated participant), the eye contact relationship. This information can be provided using peripheral system 220 and/or user interface system 230. Specifically, this information can use an input by participant via an input device such as a keyboard, mouse, keypad, touch screen and/or the like. Alternatively, or additionally, some or all of the demographic information can be obtained using image processing techniques of captured image(s) of one or more of the participants.

The system then obtains goal information (step 310). Goals can include, for example, teaching, advertising/persuasion, entertainment, selling a product or coming to an agreement, and the psychological effects to be pursued or avoided for such goals can include trust/distrust, intimidation vs. inspiration, attraction vs. repulsion, valuing vs. dismissing and so forth. Thus, for example, a goal could be to sell a product using inspiration, while another goal could be to sell a product using trust.

The goal information can also include a definition of duration or dynamics for the goal. For example, a game designer wishes a character to be intimidating and menacing under certain game conditions. In this case, the system looks at the profile and environmental information provided, and offers matches that have been classified as menacing or for which the system has been given rules to infer that the match is equivalent to menacing.

The system then obtains environmental information (step 315). The environmental information can be any type of information about the current and/or past environments of one or more of the participants. This information can include the number of participants in attendance, physical arrangement of participants, the type of device being employed by one or more participants (e.g., cell phone, wall screen, laptop, desktop, etc.), haptic, proxemic, kinesic and similar indicators as required for the proper interpretation of the nonverbal and verbal communication.

The environmental information can be obtained using, for example, peripheral devices that establish position and orientation of a viewer of the display or other viewers where such viewers constitute other sources of gaze and capture cones. To this end, position tracking, gesture tracking and gaze tracking devices along with software to analyze and apply the data from such devices can be employed by the present invention.

Exemplary peripherals that can be used for position tracking can include Global Positioning Satellite (GPS) devices that can provide latitude, longitude and/or altitude, orientation determining devices that can provide yaw, pitch and/or roll, direction of travel determining devices, direction of capture determining devices, a clock, an optical input, an audio input, accelerometer, speedometers, pedometers, audio and laser range finders and/or the like. Using one or more of the aforementioned devices also allows the present invention to employ motion detection devices so the gestures can be used as a user interface input for the system.

Relative motion tracking can also be achieved using “pixel flow” or “pixel change” monitoring devices to identify and track a moving object, where the pixel change is used to calculate the motion of the capture device relative to a stationary environment to measure changing yaw, pitch and roll as well as assisting in the overall location tracking process. For use as a yaw, pitch and roll measure useful for determining space-time segment volumes as well as a means of overall space-time line tracking, the system can include a camera system which is always on but which is not always optically recording surroundings. Instead, the camera system will always be converting, recording and/or transmitting change information into space-time coordinate information and attitude and orientation information. In addition, image science allows for face detection which tags the record with the space-time coordinates of other observers, potentially useful for later identification of witnesses and captures of an event. One or more “fish-eye” or similar lenses or mirrors useful for capturing a hemispherical view of the environment can be used for this purpose. The visual recording capability of the device may also be used in the traditional manner by the user of the device that is to create a video recording.

Environmental information can also be obtained when objects or people pass a sensor, such as optical devices such as cameras, audio devices such as microphones, radio frequency, infrared, thermal, pressure, laser scanners or any other sensor or sensor emitter system found useful for the purpose of detecting creatures and objects and identification such as RFID tags, barcodes, magnetic strips and all other forms of readily sharing a unique identification code.

Environmental information can also be obtained by comparing a background of an image of one of the participants to a database to determine the relative positions of the capture device or individual to the environment as provided by an optical sensor worn by a second participant or attached to a device worn by a second participant.

One or more participants may have a computer generated environment and the present invention can account for both a real and computer generated environment. For example, when the interaction is occurring between two avatars for real people, then there is the physical environment of each physical person and the virtual environment of each avatar. In this case, the gaze behavior of each in each environment will be employed with the other information, including the goals, to identify appropriate behaviors for the avatars as well as providing information to each individual what is being nonverbally communicated by the behavior of each avatar and what is potentially the most appropriate nonverbal response.

The system then obtains gaze cone information (step 320). Gaze cone information includes information useful for defining the shape and type of gaze cone and the vector of the gaze cone for a real or computer generated participant. For example, periods when eyes are closed attenuates the shape of the gaze cone to zero even though system is recording the direction an individual is facing and so recording a gaze vector. A typical gaze cone is constructed for an individual with two eyes, and thus is of the stereoscopic type. If the individual has one or no eyes, then a different type of gaze cone with different implications may be said to exist. Likewise for gaze cones for computer generated participants, the gaze cone may be constructed on the basis of alien anatomy and therefore alien optical characteristics including looking into a different part of the spectrum.

Returning now to FIG. 3, the system then processes the obtained information (step 325) in order to identify behavioral modifications (step 330). The processing involves converting the goal specification into gaze cone vector relationships to other gaze cone vectors and environmental targets for a gaze cone vector as well as duration and frequency of gaze and potentially additional associated environmental cuing for facial expression as well as other haptic, kinesic and proxemic accompanying actions. Specifically, the obtained gaze cone and gaze vector information of one or more participants are compared to the demographic, goal and environment information in order to identify whether the current gaze cone and gaze vector satisfies the goals in view of the demographic and/or environment information. When the obtained gaze cone and gaze vector information does not satisfy the goals, behavioral modifications that achieve the goals, in view of the demographic and/or environment information, are identified. The processing of obtained information also includes comparing the obtained information with stored information (e.g., in the form of templates) in order to identify the behavioral modifications. For example, the stored information indicates how to adjust gaze based on the obtained demographic, environmental and goal information.

The system then outputs the behavioral modification information and associated information (step 335). The behavioral modification information can include the recommendations illustrated in portion 112, and the associated information can include the gaze information of portion 108, statistics of portion 110 and the analysis information of portion 112. Specifically, the behavioral modifications include eye contact information, such as gaze direction, gaze duration, blink rate and/or the like.

The outputs can vary in the amount of information provided, and can range from one or more recommendations for achieving a goal, an analytic report on what the gaze behavior of a participant might mean, or commands used for a compute to generate one of the participants in a particular manner to achieve the goal. For example, when one of the participants is computer generated, the output can be information for simulating eye contact of various durations and other characteristics (such as facial expression, body expression and manner in which the eye contact is initiated and broken off) with a viewer(s) or alternatively choosing prerecorded segments useful for simulating different sorts of eye contact as already characterized for a synthetic character. For example, an advertiser wishes to create a sexy synthetic spokesperson, and inputs environment—specifically the target demographic second participant, the goal, and the behavior (steady eye contact), and the system can retrieve examples of individuals appropriate to delivering the message in a believable manner. Based on the reaction of the other participants, the present invention can further adapt how the computer generated participant outputs such nonverbal behaviors.

The system can also monitor one or more of the participants to determine whether the behavioral modification has been implemented, and inform the participant whether they have successfully implemented the behavioral modification. After outputting the behavioral modification, the process then returns obtain information in order to output additional behavioral modifications (steps 305-335). Although FIG. 3 illustrates steps being performed in a particular order, the steps can be performed in a different order or in parallel. For example, the various information can be obtained in a different order and/or can be obtained in parallel.

The invention has been described in detail with particular reference to certain preferred embodiments thereof, but it will be understood that variations and modifications can be effected within the spirit and scope of the invention.

1. A method comprising the acts of:
obtaining information related to a communication between a first and second participant, the obtained information including at least demographic information;
identifying, by a processor and based on the obtained information, behavioral modifications for at least one of the first and second participants; and
outputting the identified behavioral modifications.

2. The method of claim 1, wherein the identified behavioral modifications are output as a list on a display.

3. The method of claim 1, wherein one of the first and second participants is computer-generated, and the identified behavioral modifications are output to control the computer-generated participant.

4. The method of claim 1, wherein, in addition to the demographic information, the obtained information includes environmental information, goal information or gaze cone vector information.

5. The method of claim 4, wherein the demographic information is provided by one of the first and second participants.

6. The method of claim 4, wherein the demographic information is obtained by analysis of an image of one of the first and second participants.

7. The method of claim 4, wherein the demographic information includes information about gender, age, economic circumstances, profession, physical size, capabilities, disabilities, education, domicile, physical location, cultural origins or ethnicity.

8. The method of claim 4, wherein the environmental information is obtained by a sensor.

9. The method of claim 8, wherein the sensor is an image sensor.

10. The method of claim 1, wherein the identified behavioral modifications include eye contact information.

11. The method of claim 10, wherein the eye contact information includes information about a direction of a gaze and a duration of the gaze in the direction.

12. A system comprising:
an input device that obtains information related to a communication between a first and second participant, the obtained information including at least demographic information;
a processor that identifies, based on the obtained information, behavioral modifications for at least one of the first and second participants; and
an output device that outputs the identified behavioral modifications.

13. The system of claim 12, wherein the output device is a display that lists the identified behavioral modifications.

14. The system of claim 12, wherein the output device is a display, one of the first and second participants is computer-generated, and the identified behavioral modifications are output to control the display of the computer-generated participant.

15. The system of claim 12, wherein, in addition to the demographic information, the obtained information includes environmental information, goal information or gaze cone vector information.

16. The system of claim 15, wherein the demographic information is provided by one of the first and second participants.

17. The system of claim 15, wherein the demographic information is obtained by analysis of an image of one of the first and second participants.

18. The system of claim 15, wherein the demographic information includes information about gender, age, economic circumstances, profession, physical size, capabilities, disabilities, education, domicile, physical location, cultural origins or ethnicity.

19. The system of claim 15, further comprising:
a sensor, which obtains the environmental information.

20. The system of claim 19, wherein the sensor is an image sensor.

21. The system of claim 12, wherein the identified behavioral modifications include eye contact information.

22. The system of claim 21, wherein the eye contact information includes information about a direction of a gaze and a duration of the gaze in the direction.
